(19) United States
(12) Patent Application Publication
(10) Pub. No.: US 2026/0236955 A1
(43) Pub. Date: Aug. 13, 2026

(54) SYSTEM AND METHOD FOR GENERATING PROMOTIONAL PRODUCT PRICING

(71) Applicant: TARGET BRANDS, INC., Minneapolis, MN (US)

(72) Inventor: Blake KELLAR, Minneapolis, MN (US)

(21) Appl. No.: 19/051,566

(22) Filed: Feb. 12, 2025

(51) Int. Cl. G06Q 30/0201; G06Q 30/0601

(52) U.S. Cl. CPC G06Q 30/0206; G06Q 30/0641

(57) ABSTRACT

In one embodiment, a computer implemented method for generating promotional product pricing is disclosed. The method may include generating, via a processor, a data partition based on a first product characteristic, wherein the data partition includes product data; formatting, via the processor, product data of the data partition based on the first product characteristic; joining, via the processor, product data of the data partition into a local database, including: combining a first data entry and second data entry of the data partition into a third data entry based on the first product characteristic; and removing an attribute of the third data entry of the data partition; evaluating, via the processor, promotional pricing of the product data of the local database; and displaying, via the processor, the promotional pricing to a consumer.

### BACKGROUND

Businesses, such as retailers, may often market goods and services on e-commerce websites. For example, a retailer may market goods on a consumer-facing website, like a search engine, such that when a consumer searches for a product on the search engine, the search engine may display marketing for the product, including an indication of the pricing and whether any promotions, such as sales or discounts, apply to the product. Promotions may be conditional based on characteristics of the product or the consumer. For example, some promotions may apply only during a certain time period or only for consumers in a certain geographic region. As used herein, conditional pricing represents the price of a good or service subsequent to the application of a conditional promotion.

Conventionally, calculating conditional pricing requires prohibitively long computational processing time and may not be scalable where there are a large number of products and conditional promotions. For example, conducting load-time calculations of conditional pricing (e.g., via a consumer facing API) requires searching across multiple large databases and making multiple network calls to parse the data, which will significantly increase the load time of the website. Increased load time may subsequently decrease the conversion rate of the advertisement. Similarly, pre-calculating the conditional pricing would conventionally require joining large product databases which may require computational time in the order of magnitude of days.

### BRIEF SUMMARY

In one embodiment, a computer implemented method for generating promotional product pricing is disclosed. The method may include generating, via a processor, a data partition based on a first product characteristic, wherein the data partition includes product data; formatting, via the processor, product data of the data partition based on the first product characteristic; joining, via the processor, product data of the data partition into a local database, including: combining a first data entry and second data entry of the data partition into a third data entry based on the first product characteristic; and removing an attribute of the third data entry of the data partition; evaluating, via the processor, promotional pricing of the product data of the local database; and displaying, via the processor, the promotional pricing to a consumer.

Optionally, in some embodiments, the data partition includes domains for price, promotion, item, and item location service.

Optionally, in some embodiments, the first product characteristic includes a stock keeping unit (SKU) identifier.

Optionally, in some embodiments, generating the data partition includes generating a highly composite number of data partitions to enable horizontal scaling of the data partitions.

Optionally, in some embodiments, generating the data partition based on the first product characteristic includes: retrieving a product database; executing a hash function on product data of the product database based on the first product characteristic; and allocating the product data into the data partition based on the output of the hash function.

Optionally, in some embodiments, removing the attribute of the third data entry of the data partition includes: retrieving a promotion policy; determining an attribute of the third data entry unrelated to the promotion policy; and removing the attribute from the third data entry.

Optionally, in some embodiments, formatting the product data of the data partition based on the first product characteristic includes: determining an attribute class of the first product characteristic; and formatting a data entry of the data partition to include the attribute class.

Optionally, in some embodiments, combining the first data entry and second data entry of the data partition into the third data entry based on the first product characteristic includes: determining the first product characteristic of the first data entry; determining the first product characteristic of the second data entry; determining that the first product characteristic of the first data entry is equivalent to the first product characteristic of the second data entry; and combining a first data entry and the second data entry into a third data entry, wherein duplicate attributes of the first data entry and second data entry are removed.

Optionally, in some embodiments, joining the product data of the data partition into the local database further includes: executing a hash function on the product data based on a second product characteristic; and sorting the product data into the local database based on the output of the hash function.

Optionally, in some embodiments, the second product characteristic represents a target characteristic of a conditional promotion and includes one of a consumer characteristic, consumer location characteristic, product item characteristic, product class characteristic, store location characteristic, or manufacture characteristic.

Optionally, in some embodiments, evaluating promotional pricing of the product data of the local database includes: retrieving a conditional promotion policy; designating a promotional product based on the conditional promotion policy; and calculating a conditional pricing of the promotional product based on the conditional promotion policy and the product data.

Optionally, in some embodiments, displaying the promotional pricing to a consumer includes: transmitting the promotional pricing to a search engine system; and displaying the promotional pricing to the consumer based on a search query input to the search engine system by the consumer.

In another embodiment, a system for generating promotional product pricing is disclosed. The system may include a product database; a local database; and a processor configured by instructions to perform operations including: generating a data partition based on a first product characteristic, wherein the data partition includes product data of the product database; formatting product data of the data partition based on the first product characteristic; joining product data of the data partition into the local database, including: combining a first data entry and second data entry of the data partition into a third data entry based on the first product characteristic; and removing an attribute of the third data entry of the data partition; evaluating promotional pricing of the product data of the local database; and displaying the promotional pricing to a consumer.

Optionally, in some embodiments, generating the data partition based on the first product characteristic includes: retrieving a product database; executing a hash function on product data of the product database based on the first product characteristic; and allocating the product data into the data partition based on the output of the hash function.

Optionally, in some embodiments, removing the attribute of the third data entry of the data partition includes: retrieving a promotion policy; determining an attribute of the third data entry unrelated to the promotion policy; and removing the attribute from the third data entry.

Optionally, in some embodiments, formatting the product data of the data partition based on the first product characteristic includes: determining an attribute class of the first product characteristic; and formatting a data entry of the data partition to include the attribute class.

Optionally, in some embodiments, combining the first data entry and second data entry of the data partition into the third data entry based on the first product characteristic includes: determining the first product characteristic of the first data entry; determining the first product characteristic of the second data entry; determining that the first product characteristic of the first data entry is equivalent to the first product characteristic of the second data entry; and combining a first data entry and the second data entry into a third data entry, wherein duplicate attributes of the first data entry and second data entry are removed.

Optionally, in some embodiments, joining the product data of the data partition into the local database further includes: executing a hash function on the product data based on a second product characteristic; and sorting the product data into the local database based on the output of the hash function.

Optionally, in some embodiments, evaluating promotional pricing of the product data of the local database includes: retrieving a conditional promotion policy; designating a promotional product based on the conditional promotion policy; and calculating a conditional pricing of the promotional product based on the conditional promotion policy and the product data.

Optionally, in some embodiments, displaying the promotional pricing to a consumer includes: transmitting the promotional pricing to a search engine system; and displaying the promotional pricing to the consumer based on a search query input to the search engine system by the consumer.

### BRIEF DESCRIPTION OF THE SEVERAL VIEWS OF THE DRAWINGS

FIG. 1 illustrates an example of a computer-implemented promotional pricing system.

FIG. 2 is a flow diagram for computing promotional pricing with the promotional pricing system of FIG. 1.

FIG. 3 is a flow diagram for displaying promotional pricing with the promotional pricing system of FIG. 1.

FIG. 4 illustrates an example diagram for computing promotional pricing as described with respect to method 200.

FIG. 5 illustrates an example user interface for displaying promotional pricing as described with respect to method 300.

FIG. 6 is a block diagram of an example computer system suitable for use in the promotional pricing system of FIG. 1.

### DETAILED DESCRIPTION

The system and methods described herein may include a promotional pricing system that calculates and displays conditional and unconditional pricing for goods and services with reduced processing time requirements. The promotional pricing system reduces the run time needed to calculate product pricing to enable accurate pricing display to consumers. The system may calculate both the application of conditional and unconditional discounts to products.

The promotional pricing system calculates promotional pricing by partitioning, formatting, and reducing product databases into one or more local databases. By partitioning the large product databases into smaller local databases, the promotional pricing system may calculate promotional pricing for products in the local databases without requiring any network connection or API calls. In this manner, the promotional pricing system may calculate promotional pricing at a reduced computational cost to provide real-time display of product promotional pricing to consumers.

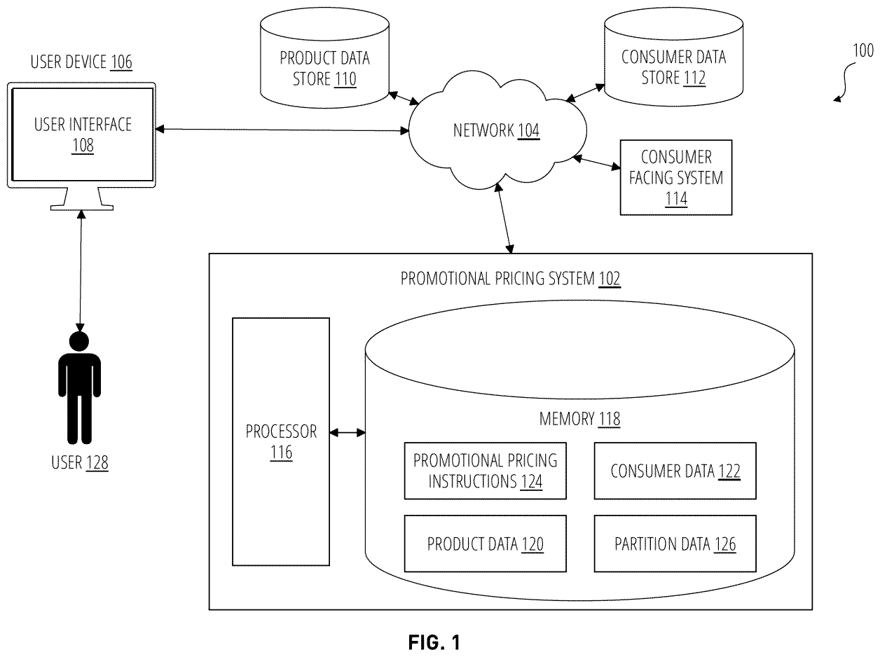

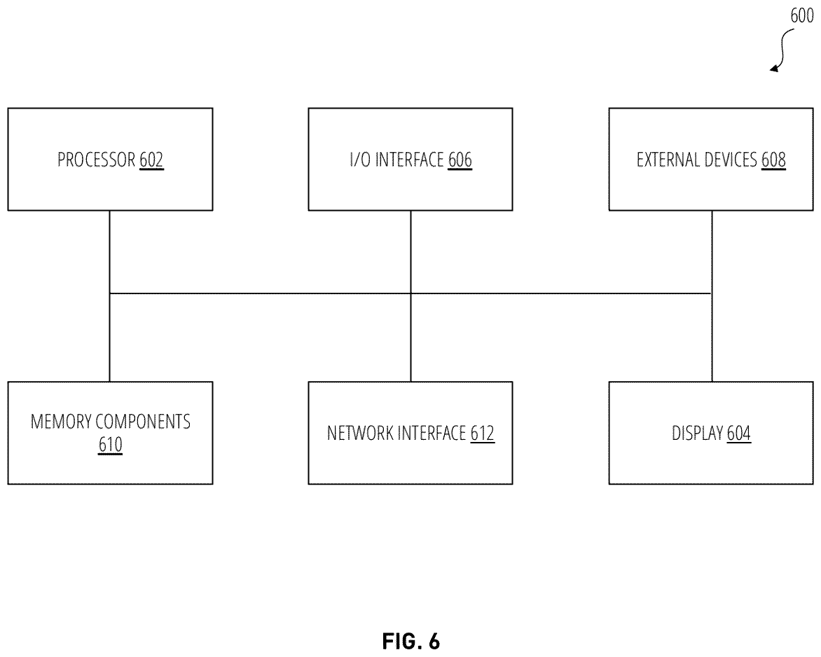

Turning now to the figures, FIG. 1 illustrates an example system 100. The system 100 calculates promotional pricing of a product and displays the promotional pricing to a user 128 via a user device 106. The system 100 includes a user device 106, a product data store 110, a consumer data store 112, and a consumer facing system 114 in communication with a promotional pricing system 102 either directly or via a network 104. In some embodiments, the promotional pricing system 102 includes a memory 118 and a processor 116. The memory 118 may include or access various types of data or instructions used by the promotional pricing system 102. Such data and instructions may include promotional pricing instructions 124, product data 120, consumer data 122, and partition data 126 in various examples. Such data and instructions may be stored on and/or executed by a computing device as described with respect to FIG. 6.

The promotional pricing system 102 and consumer facing system 114 is accessible by a user 128 through a user interface 108 provided by the user device 106, e.g., through a software application. In some embodiments, the promotional pricing system 102 may be in communication with one or more user devices 106, one or more product data stores 110, one or more consumer data stores 112, and one or more consumer facing systems 114. In some embodiments, the promotional pricing system 102, product data store 110, consumer data store 112, and consumer facing system 114 may be incorporated into the user device 106 as an application rather than as a separate system.

In some embodiments, a user 128 may engage with the system 100 through a user device 106. In some examples, the user 128 may be a consumer or potential consumer of products marketed and displayed with the system 100. For example the user 128 may be a consumer querying a consumer facing system 114, such as an online search engine, about a certain product, and the system 100 may display information regarding the product, including conditional and/or unconditional promotion pricing information, to the user 128 via the search engine.

In some embodiments, the user device 106 may be a device utilized by a user 128. The user device 106 may communicate with the promotional pricing system 102 (e.g., via the network 104). The user device 106 and network 104 are discussed in more detail with respect to FIG. 6. In some examples, the promotional pricing system 102 is executed on the user device 106. In such examples, communication between the promotional pricing system 102 and user device 106 may not be via network 104. In some examples, a user 128 may input a request to generate promotional pricing for a product through the user interface 108. The user device 106 may communicate the request to the promotional pricing system 102. The promotional pricing system 102 may generate the promotional pricing for the product and display the promotional pricing for the product to the user 128 via the user interface 108.

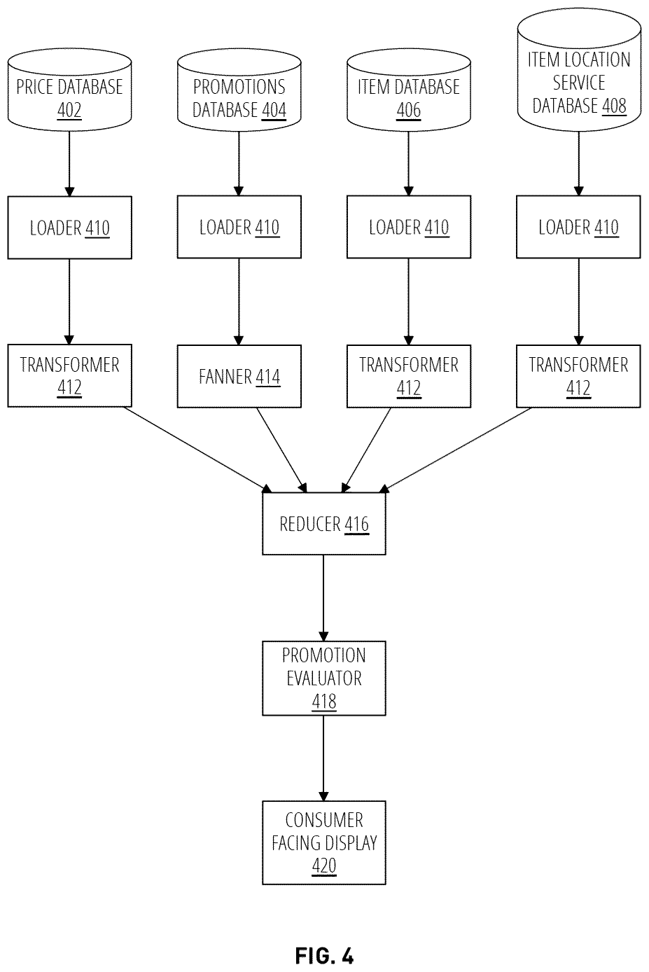

In some embodiments, the promotional pricing system 102 may be in communication with a product data store 110. The product data store 110 may include memory storage (e.g., in a server) for storing product data. For example, as portrayed in FIG. 4, the product data store 110 may include a price database 402, promotions database 404, item database 406, and item location service database 408. The price database 402 may include data on the pricing of all products offered or marketed by a retailer. The promotions database 404 may include information regarding promotions which may apply to products offered or marketed by a retailer. The promotions database 404 may include conditional and/or unconditional promotion policies and the conditional and/or unconditional terms for the promotions. The item database 406 may include data on all product items offered or marketed by the retailer, including product characteristics. The item location service database 408 may include data on the location of product items offered or marketed by the retailer. The product data store 110 may be implemented as one storage device (e.g., physical device) or distributed across various storage devices.

In some embodiments, the promotional pricing system 102 may be in communication with a consumer data store 112. The consumer data store 112 may include memory storage (e.g., in a server) for storing consumer data. For example, the consumer data store 112 may include one or more databases for storing consumer location data, consumer purchase history data, and other such data. The consumer data store 112 may be implemented as one storage device (e.g., physical device) or distributed across various storage devices.

In some embodiments, the promotional pricing system 102 may be in communication with a consumer facing system 114. The consumer facing system 114 may include retail websites, online search engines, or other such platforms configured to display marketing materials to consumers. For example, the consumer facing system 114 may include an online search engine configured to receive a consumer query regarding a product, generate a search result in response to the query, and display the search result including marketing materials related to the product, such as images of the product, pricing, and any applicable promotions. In other examples, the consumer facing system 114 may be a retail or ecommerce website configured to market products and facilitate the sale of products to consumers. In some examples, the consumer facing system 114 may be hosted internally by the promotional pricing system 102, and in other examples, the consumer facing system 114 may be hosted externally (e.g., on a third-party website).

In some embodiments, the promotional pricing system 102 includes product data 120 stored e.g., on the memory 118. The product data 120 may store data related to products sold or advertised by a business. For example, the product data 120 may include product identifiers (e.g., SKU numbers), product item characteristics, product class characteristics, product store locations, product manufacture characteristic, product pricing information, and the like. For example, product data 120 may include a database of product items including the SKU number for each item, the pricing of the item, and where the item is located.

The promotional pricing system 102 may receive the product data 120 from the user device 106 and/or product data store 110 (e.g., via the network 104). For example, as portrayed in FIG. 4, the promotional pricing system 102 may retrieve data from the price database 402, promotions database 404, item database 406, and/or item location service database 408 of the product data store 110 and store the product data 120 in memory 118.

In some embodiments, the promotional pricing system 102 includes consumer data 122 stored e.g., on the memory 118. The consumer data 122 may store data related to consumers. For example the consumer data 122 may include consumer profile information, consumer location information, and consumer sales history information.

The promotional pricing system 102 may receive the consumer data 122 from the user device 106 and/or consumer data store 112 (e.g., via the network 104). For example, when a user 128 inputs a search query for a product into a search engine of the consumer facing system 114 via the user device 106, the promotional pricing system 102 may retrieve the location of the user 128 from the user device 106 and store the product data 120 in memory 118.

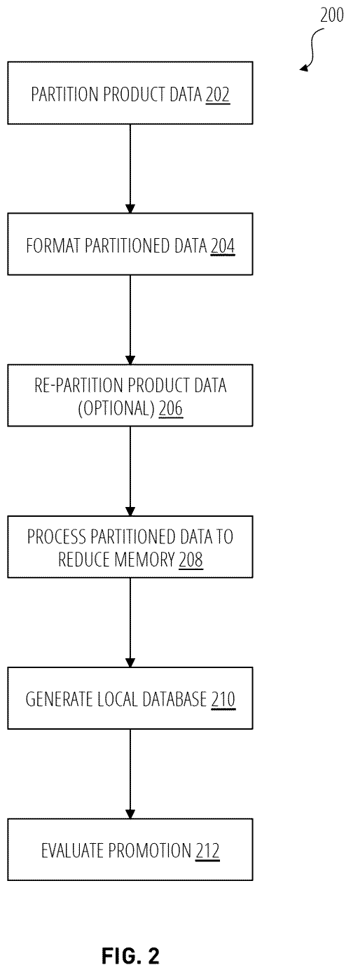

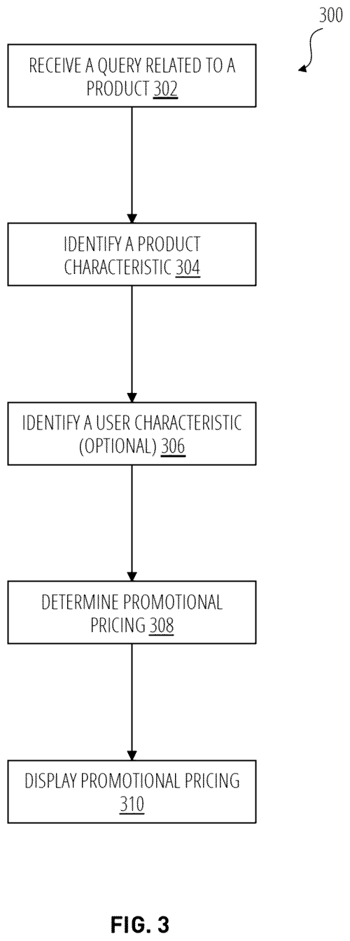

In some embodiments, the promotional pricing system 102 includes promotional pricing instructions 124 stored e.g., on the memory 118. The promotional pricing instructions 124 may, when executed by the processor 116, generate and/or display promotional pricing for a product based on product data 120 and consumer data 122 (e.g., as according to method 200 and/or method 300). The promotional pricing instructions 124 may include instructions to partition a product database of the product data 120, format the product database, process the product data of the product database, re-partition the product database, generate a local database (e.g., a local database stored in partition data 126 of the memory 118), evaluate a conditional and/or unconditional promotion of a product based on the local database, and display the promotion to the user 128 (e.g., via the user interface 108). The promotional pricing instructions 124 are described in further detail with respect to FIG. 2 and FIG. 3.

In some embodiments, the promotional pricing system 102 includes partition data 126 stored e.g., on the memory 118. The partition data 126 may store product data that has been partitioned and formatted by the promotional pricing system 102 according to the promotional pricing instructions 124. For example, the promotional pricing system 102 may retrieve product data 120 from the product data store 110, partition and format the product data 120 according to the promotional pricing instructions 124, and store the partitioned and formatted product data 120 into a local database of the partition data 126.

While the data and instructions, such as the product data 120, consumer data 122, promotional pricing instructions 124, and partition data 126 are shown in FIG. 1 as being stored in the memory 118, in some examples, the data and instructions may be stored at other memory resources of the promotional pricing system 102 and/or at locations remote from the promotional pricing system 102, such as various databases or data stores (e.g., the product data store 110 and/or the consumer data store 112). In such examples, the memory 118 of the promotional pricing system 102 may include instructions for accessing such data and instructions from remote locations, including, for example, the locations of the data and/or specific queries used to retrieve data for use by the promotional pricing system 102. For example, where the consumer data 122 is stored in the consumer facing system 114, memory 118 may include instructions for how to retrieve or access the data from the consumer facing system 114.

The promotional pricing system 102 may be implemented by or at a computing device or combinations of computing resources in various embodiments. In various examples, the promotional pricing system 102 may be implemented by one or more servers, cloud computing resources, and/or other computing devices. The promotional pricing system 102 may, for example, be incorporated as a module within a mobile application, software application, or a website presented through a web browser (e.g., at a laptop or desktop computer), and the like.

The components of FIG. 1 are exemplary only. In various examples, the promotional pricing system 102 may communicate with and/or include additional components and/or functionality not shown in FIG. 1. For example, the promotional pricing system 102 may communicate with multiple consumer facing systems 114, such as different search engines and retail websites. Although not shown in FIG. 1, the promotional pricing system 102 may also be in communication with other systems or components. For example, the promotional pricing system 102 may communicate with other marketing systems or platforms.

FIG. 2 illustrates an example method 200 for generating promotional pricing based on product data 120 and consumer data 122 with the promotional pricing system 102. The method 200 may partition, format, and reduce product data 120 into one or more local databases of the partition data 126 to reduce the computational cost of calculating conditional and/or unconditional promotion pricing for a catalog of goods and/or services.

In operation 202, the promotional pricing system 102 partitions product data 120 into one or more data partitions. The promotional pricing system 102 may retrieve product data 120 from a product data store 110 (e.g., via the network 104). FIG. 4 portrays an example flow diagram of the operations of method 200. As portrayed with respect to FIG. 4, the product data store 110 may include one or more databases containing product information, such as a price database 402, promotions database 404, item database 406, and/or item location service database 408. In some examples, the price database 402 may include information of products available for marketing or sale, including the price of the products. The promotions database 404 may include information of products available for marketing or sale, including promotions applicable to the products. The item database 406 may include information of products available for marketing or sale, including characteristics of the products. The item location service database 408 may include information of products available for marketing or sale, including the location of the products. In some examples, the databases may contain duplicate information and/or attributes of the same products. In other examples, the information and/or attributes of certain products may be included in some of the databases and excluded from some of the databases. For example, information regarding a Toy Set A may be included in all databases, while information regarding a Toy Set B may be included in the price database 402 and promotions database 404, but may be excluded from the item database 406 and item location service database 408. Further, regarding Toy Set A, a product identifier (e.g., an SKU number) for the Toy Set A may be included in the data entry for Toy Set A in all databases, but certain attributes, such as the base price of Toy Set A may be included in the Toy Set A data entry in some databases (e.g., the price database 402) and excluded from some databases (e.g., the promotions database 404, item database 406, and item location service database 408).

The promotional pricing system 102 may partition the product data 120 retrieved from the product data store 110 into one or more data partitions. The promotional pricing system 102 may partition the product data 120 such that data with common features and/or attributes are partitioned into the same local database. For example, data related to the same product or related to the same product class may be partitioned into the same data partition. In some examples, the promotional pricing system 102 may apply a first algorithmic function to partition the product data 120. For example, the promotional pricing system 102 may apply a first hash function that hashes a feature of each product contained in the product data 120 and outputs a hash value indicating the data partition for each product. In some examples, the hashed feature is an attribute common to all data entries in the product data 120. For example, where each data entry in the product data 120 includes a product identifier, such as an SKU number, the first hash function may hash the SKU number to partition the product data 120 into data partitions. The promotional pricing system 102 may store the data partitions in memory 118 (e.g., in partition data 126).

In some examples, the promotional pricing system 102 may determine number of data partitions based on the horizontal scalability of the data partitions. For example, the promotional pricing system 102 may partition the product data 120 into a highly composite number of data partitions, such as twenty-four data partitions. As used herein, a highly composite number represents a number with a high number of divisors. In this manner, the promotional pricing system 102 may have multiple options for how to scale the number of data partitions to a higher or lower number of data partitions while maintaining a uniform memory load in each data partition. For example, where there are twenty-four data partitions, the promotional pricing system 102 may scale the number of data partitions up to thirty-six while maintaining uniform memory load by re-partitioning one-third of each of the twenty-four data partitions into twelve new partitions.

In operation 204, the promotional pricing system 102 formats the data of the data partitions into a data format accessible by the promotional pricing system 102 and/or the consumer facing system 114. For example, the data partitions may include data structured in multiple formats. The promotional pricing system 102 may reformat the data of the data partitions to a common data format that is utilizable by the promotional pricing system 102. In some examples, the promotional pricing system 102 may format the data such that each data entry in the data partition includes at least one common attribute. For example, the promotional pricing system 102 may format the data partition such that all data entries in the data partition include an SKU number attribute and a product class attribute. In some examples, the consumer facing system 114 may require data of specific formats. In such examples, the promotional pricing system 102 may reformat the data of the data partitions to the format required by the consumer facing system 114. For example, a search engine may require product marketing data to be formatted with a specific data format. The promotional pricing system 102 may format the data of the data partitions as required by the search engine. As portrayed in FIG. 4, the loader 410 may format the data of the data partitions as described with respect to operation 204. The promotional pricing system 102 may store the formatted data partitions in memory 118 (e.g., in partition data 126).

In operation 206, the promotional pricing system 102 may optionally re-partition the data partitions to balance the computational cost of processing data and calculating promotional pricing across the data partitions. For example, certain classes of products may require more computational time when processing the data of the product class or when calculating conditional pricing for the product class. The promotional pricing system 102 may re-partition the data partitions such that data entries of this product class are spread between multiple data partitions so that no single data partition would contain all the data entries of the product class and require greater computational processing time. The promotional pricing system 102 may apply a second algorithmic function to redistribute and/or repartition the data of the data partitions. For example, the promotional pricing system 102 may apply a second hash function that hashes on an attribute that is common to all data entries in the data partition but distinct from the attribute hashed with the first hash function. For example, where the first hash function hashed data entries on the product SKU number, the second hash function may hash data entries of the data partition on the product class. The hash function may hash the data entries such that data entries of the same product class are divided equally between the one or more data partitions. As portrayed in FIG. 4, the fanner 414 may optionally re-partition the data partitions as described with respect to operation 206. The re-partitioned data partitions may be stored in memory 118 (e.g., in partition data 126).

In operation 208, the promotional pricing system 102 processes the data of the data partitions to reduce the memory size of the data partitions. The promotional pricing system 102 may remove unneeded attributes from data entries of the data partitions and/or join data entries associated with a same product. Data entries of the data partitions may include attributes that are not required for the generation of conditional and/or unconditional promotion pricing. The promotional pricing system 102 may remove these unneeded attributes from the data entries. For example, product data partitioned from the item database 406 may include an attribute indicating a variety of colors that the products are available in. Where this attribute does not affect the promotional pricing of any product, the promotional pricing system 102 may remove this attribute from all data entries of the data partitions. As portrayed in FIG. 4, the transformer 412 may remove unneeded attributes of the data partitions as described with respect to operation 208. The data partitions may include multiple data entries related to the same product. The promotional pricing system 102 may join the related data entries into a single data entry in the data partition. For example, a data partition may include four data entries with the same SKU number which were originally partitioned from four different databases. Since the common SKU number indicates that the four data entries relate to the same product, the promotional pricing system 102 may join the four data entries into a single data entry in the data partition. As portrayed in FIG. 4, the reducer 416 may join the data entries of a data partition as described with respect to operation 208. The promotional pricing system 102 may store the processed data partitions in memory 118 (e.g., in partition data 126).

By processing the data entries of the data partitions, the promotional pricing system 102 may consolidate duplicate product entries and significantly reduce the memory required to store the product data 120. In turn, this may significantly reduce the memory access time and processing time required to calculate the promotional pricing for products in each data partition.

In operation 210, the promotional pricing system 102 generates one or more local databases to store the processed data partitions. In some examples, the promotional pricing system 102 may generate a local database for each data partition. In other examples, the promotional pricing system 102 may generate local databases such that a plurality of data partitions are stored in a single local database. The promotional pricing system 102 may store the local databases containing the processed data partitions in memory 118 (e.g., in partition data 126).

In operation 212, the promotional pricing system 102 analyzes the data entries of the data partitions to evaluate and apply any applicable promotions to the products represented in the data entries. The promotional pricing system 102 may retrieve promotion policies from a database of the product data store 110, such as the promotions database 404 (e.g., via the network 104).

The promotion policies may include rules or policies for conditional and/or unconditional promotions. An unconditional promotion policy may define a promotion applicable to a product or product class without condition. For example, an unconditional promotion policy may designate a 10% discount for all products with a specified SKU number. A conditional promotion policy may define a promotion applicable to a product or product class only if one or more conditions are met. Conditions may be based on characteristics of the product or consumer, such as a consumer characteristic, consumer location characteristic, product item characteristic, product class characteristic, store location characteristic, or manufacture characteristic. For example, a conditional promotion policy may designate a 10% discount on products with a specified SKU number if the location of the store holding the product is within one hundred miles of the location of the consumer.

The promotional pricing system 102 may evaluate each data entry of the one or more data partitions to calculate and apply any applicable conditional and/or unconditional promotion policies to the products represented by the data entries to generate promotion pricing for the products. In some examples, the promotional pricing system 102 may pre-calculate a promotion for a product prior to receiving any query (e.g., a query from a user 128) regarding the product. For example, the promotional pricing system 102 may pre-calculate all unconditional promotions for products. In some examples, the promotional pricing system 102 may calculate a promotion for a product after receiving a query regarding the product. For example, where a conditional promotion depends on a consumer characteristic, such as the location of the consumer, the promotional pricing system 102 may calculate the conditional promotion after receiving a user 128 query regarding the product and after receiving a location of the user 128. As portrayed in FIG. 4, the promotion evaluator 418 may evaluate the data partitions to generate promotion pricing, as described with respect to operation 210. The promotional pricing system 102 may store the promotional pricing in memory 118 (e.g., in partition data 126 and/or product data 120).

In some examples, where the promotional pricing system 102 has generated a plurality of data partitions, a plurality of processors 116 may be utilized to computing promotional pricing for the data partitions. For example, where the promotional pricing system 102 generates twenty-four data partitions, the promotional pricing system 102 may utilize at least twenty-four processors 116 to compute promotional pricing, where each data partition has at least one processor dedicated to computing promotional pricing for products contained in the data partition. In such examples, the processor 116 and data partition may be located in the same system such that no network calls are required for the communication between the processor 116 and data partition. By dividing the calculation of promotional pricing between one or more processors per data partition, the promotional pricing system 102 may calculate promotional pricing with increased processing speed and horizontal scalability.

In some examples, where the promotion policy of a product changes or expires, the promotional pricing system 102 may re-evaluate the data entry related to the product in the applicable data partition. For example, where a product is subject to a conditional promotion that is conditioned to apply only during a specified date range, after the conclusion of the date range, the promotional pricing system 102 may access the data partition of the product to re-evaluate whether any promotion policies apply to the product. Due to the partitioning and processing of the product data 120 into multiple data partitions, the promotional pricing system 102 only needs to access the single data partition related to the product in order to re-evaluate the promotion policies for the product. This significantly decreases the memory access time and processing time required to re-evaluate promotion policies.

FIG. 3 illustrates an example method 300 for displaying promotional pricing of a product to a user 128. In operation 302, the promotional pricing system 102 receives a query related to a product from a user 128. The user 128 may input a query related to a product or product class available for sale or marketing via a user interface 108 of the consumer facing system 114. For example, the user 128 may search for a product on an online search engine, or the user 128 may interface with a retail website to browse categories of product classes. The consumer facing system 114 and/or user device 106 may communicate the user 128 query to the promotional pricing system 102 (e.g., via the network 104).

In operation 304, the promotional pricing system 102 identifies a product characteristic based on the user 128 query. The promotional pricing system 102 may evaluate the user 128 query to determine the product queried by the user 128 and identify a product characteristic of the product. The product characteristic may include a product name, product identifier, product class, product image, base product price, or the like. For example, the promotional pricing system 102 may identify an SKU number associated with the product queried by the user 128.

In operation 306, the promotional pricing system 102 optionally identifies a user characteristic based on the user 128 query. Along with the query received from the user 128 at operation 302, the promotional pricing system 102 may also receive characteristics of the user 128, such as user profile information, purchase history, product search history, product browsing history, product cart history, a location of the user 128, or the like. Where the product queried by the user is associated with a conditional promotion policy, the promotional pricing system 102 may identify a user characteristic of the user 128 related to the conditional promotion policy. For example, where the product queried by the user 128 is subject to a conditional promotion policy based on the location of the consumer, the promotional pricing system 102 may identify the location of the user 128. In another example, where the product queried by the user 128 is subject to a conditional promotion policy based on the number of previous products purchased by the consumer, the promotional pricing system 102 may identify the purchase history of the user 128. Where the product queried by the user is associated with an unconditional promotion policy, the promotional pricing system 102 may identify a user characteristic of the user 128 where the unconditional promotion policy depends on a user characteristic. For example, where an unconditional promotion policy indicates that all consumers in a geographic region receive a 10% on all products, the promotional pricing system 102 may identify the location of the user 128.

In operation 308, the promotional pricing system 102 determines the promotional pricing of the product queried by the user 128 based on the product characteristic and/or the user characteristic. The promotional pricing system 102 may access the promotional pricing database generated with method 200 and stored in memory 118 to determine the promotional pricing associated with the product queried by the user 128. For example, the promotional pricing system 102 may access the local database containing the data partition that includes the data entry associated with the SKU number of the product queried by the user 128. The promotional pricing system 102 may access the associated data entry to determine a conditional and/or unconditional promotional pricing associated with the SKU number.

In operation 310, the promotional pricing system 102 causes display of the promotional pricing for the product queried by the user 128 on the consumer facing system 114 (e.g., via the user device 106). The promotional pricing system 102 may transmit the promotional pricing associated with the product queried by the user 128 to the consumer facing system 114 (e.g., via the network 104). The consumer facing system 114 may display product marketing information for the product queried by the user 128, including the promotional pricing and/or product information, to the user 128 through a user interface 108. For example, as portrayed in FIG. 4, the product marketing information may be displayed with the consumer facing display 420. In some examples, the user interface 108 may be configured to additionally allow the user 128 to interact with the product marketing information to place an order for the product or link the user 128 to a retail website where the product is sold.

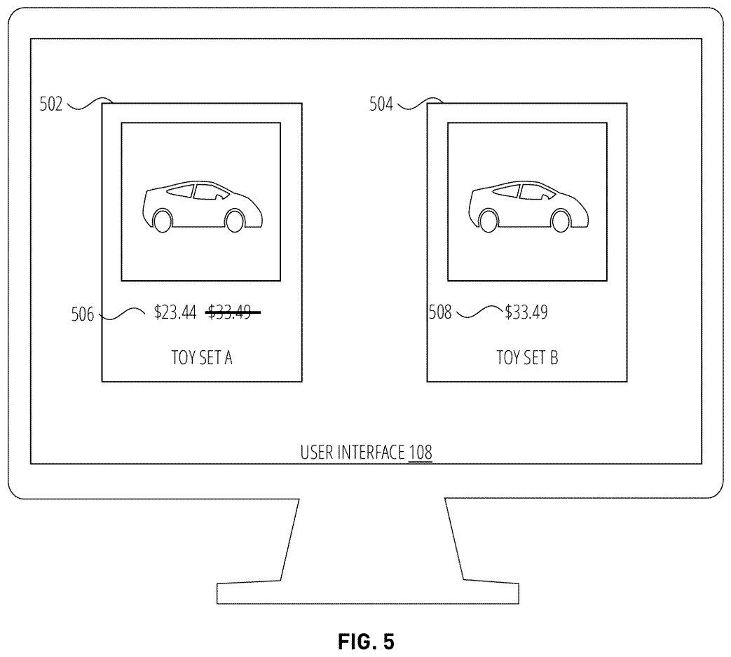

FIG. 5 portrays an example user interface 108 for displaying product marketing information, as described with respect to operation 310, for a Toy Set A in user interface element 502 and product marketing information for a Toy Set B in user interface element 504. The user interface elements 502 and 504 may display product information of Toy Set A and Toy Set B, such as the name of the product, retailer associated with the product, image of the product, consumer rating of the product, and the like. Additionally, the user interface elements 502 and 504 may display pricing information such as with pricing displays 506 and/or 508. For example, pricing display 508 displays the base price of Toy Set B without any promotional pricing indication, e.g., where no promotional pricing is applicable to Toy Set B. Pricing display 506 displays a promotional pricing for Toy Set A. For example, the promotional pricing of Toy Set A (e.g., “$23.44”) is displayed adjacent to the base price of Toy Set A (e.g., “$33.49”), where the base price is struck through to indicate that the base price does not apply and that the promotional pricing discount does apply.

The components of FIG. 5 are exemplary only. In various examples, the user interface 108 may be configured to display and/or include additional components and/or functionality not shown in FIG. 5.

FIG. 6 illustrates a block diagram of an example computer system suitable for use in embodiments disclosed herein in accordance with an embodiment of the disclosure. For example, the promotional pricing system 102 may include or utilize one or several computing systems 600, and the processor 116 and memory 118 may be located at one or several computing systems 600. In various embodiments, the consumer facing system 114 is implemented by a computing system 600. In various implementations, the user device 106 and/or additional user devices may be implemented using any number of computing devices including, but not limited to a computer, laptop, tablet, mobile phone, smart phone, wearable device (e.g., AR/VR headset, smartwatch, smart glasses, or the like), smart speaker, vehicle (e.g., automobile), or appliance.

This disclosure contemplates any suitable number of computing systems 600. For example, the computing system 600 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 600 may include one or more computing systems; be unitary or distributed; span multiple locations; span multiple machines; span multiple data centers; or reside in a cloud, which may include one or more cloud components in one or more networks. The computing system 600 may include one or more processors 602, an input/output (i/o) interface 606, one or more external devices 608, one or more memory components 610, and a network interface 612. Each of the various components may be in communication with one another through one or more buses or communication networks, such as wired or wireless networks.

In some embodiments, various components of the computing system 600 may communicate with one another through the network 104. For example, in some embodiments, the computing system 600 may be implemented as a serverless service, where computing resources for various components of the computing system 600 may be located across various computing environments (e.g., cloud platforms) and may be reallocated dynamically and/or automatically according to, for example resource usage of the computing system 600. In various implementations, the computing system 600 may be implemented using organizational processing constructs such as functions implemented by worker elements allocated with compute resources, containers, virtual machines, and the like.

The processor 602 may be any type of electronic device capable of processing, receiving, and/or transmitting instructions. For example, the processor 602 may be a central processing unit, graphics processing unit, microprocessor, processor, or microcontroller. Additionally, it should be noted that some components of the computing system 600 may be controlled by a first processor and other components may be controlled by a second processor, where the first and second processors may or may not be in communication with each other. The promotional pricing system 102, consumer facing system 114, and user device 106 may perform operations by executing executable instructions (e.g., software) using the processor 602. The processor 602 may be used to implement processor 116 shown in FIG. 1.

The i/o interface 606 allows a user to enter data in to computing system 600, as well as provides an input/output for the computing system 600 to communicate with other devices or services. The i/o interface 606 can include one or more input buttons, touch pads, and so on.

The external devices 608 are one or more devices that can be used to provide various inputs to the computing system 600, e.g., mouse, microphone, keyboard, trackpad, or the like. The external devices 608 may be local or remote and may vary as desired. In some examples, the external devices 608 may also include one or more additional sensors.

The memory components 610 are used by the computing system 600 to store instructions for the processor 602 and may be implemented as a data store and the like. The memory components 610 may be, for example, magneto-optical storage, read-only memory, random access memory, erasable programmable memory, flash memory, or a combination of one or more types of memory components. The memory components 610 may be used to implement the memory 118 shown in FIG. 1. The memory 118 may include various instructions for various functions of the promotional pricing system 102 which, when executed by the processor 116, perform various functions of the promotional pricing system 102. The memory 118 may further store data and/or instructions for retrieving data used by the promotional pricing system 102. Similar to the processor 116, the memory 118 utilized by the promotional pricing system 102 may be distributed across various physical computing devices. In some examples, the memory 118 may access instructions and/or data from other devices or locations, and such instructions and/or data may be read into memory 118 to implement the promotional pricing system 102.

The network interface 612 provides communication to and from the computing system 600 to other devices. The network interface 612 includes one or more communication protocols, such as, but not limited to WI-Fl®, Ethernet, BLUETOOTH®, and so on. The network interface 612 may also include one or more hardwired components, such as a Universal Serial Bus (USB) cable, or the like. The configuration of the network interface 612 depends on the types of communication desired and may be modified to communicate via WI-Fl®, BLUETOOTH®, and so on.

The network interface 612 may interface with the network 104. The network 104 may be implemented using one or more wired and/or wireless systems and protocols for communications between computing devices. In various embodiments, the network 104 or various portions of the network 104 may be implemented using the internet, a local area network, a wide area network, and/or other networks. In addition to traditional data networking protocols, in some embodiments, data may be communicated according to protocols and/or standards including near field communication, Bluetooth®, Wi-Fi, cellular connections, or the like.

The display 604 provides a visual output for the computing devices and may be varied as needed based on the device. The display 604 may be configured to provide visual feedback to the user and may include a liquid crystal display screen, light emitting diode screen, plasma screen, or the like. In some examples, the display 604 may be configured to act as an input element for the user through touch feedback or the like.

The components in FIG. 6 are exemplary only. In various examples, the computing system 600 may include additional components and/or functionality not shown in FIG. 6.

Accordingly, the promotional pricing system 102 described herein addresses particular challenges and needs presented by systems for generating promotional pricing of goods and/or services. For example, where a business has a large catalog of goods and/or services spread between multiple large databases, calculating the promotional price of a product in response to a user query may (e.g., via an API call) may significantly increase the load time of the user interface page. With increased load times for the product marketing materials, the user is less likely to engage with the product marketing materials and/or purchase the product. Similarly, traditional methods for pre-calculating promotional prices for all products in a catalog may require prohibitively long processing time in the order of magnitude of days. The promotional pricing system 102 described herein partitions product data into one or more data partitions and processes the data to reduce the memory access time and processing time required to calculate the promotional pricing for the products represented in the data partitions. In this manner, the promotional pricing system 102 may generate and display promotional pricing for products at a reduced load time.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a nontransitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description therefore is not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 200 and method 300) depict a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and Intended spirit and scope of the present system as set forth in the claims that follow. Accordingly, the specification and figures are to be regarded in an illustrative manner and are not intended to limit the scope of the appended claims.

What is claimed is:

1. A computer implemented method for generating promotional product pricing, comprising:
generating, via a processor, a data partition based on a first product characteristic, wherein the data partition comprises product data;
formatting, via the processor, product data of the data partition based on the first product characteristic;
joining, via the processor, product data of the data partition into a local database, comprising:
combining a first data entry and second data entry of the data partition into a third data entry based on the first product characteristic; and
removing an attribute of the third data entry of the data partition;
evaluating, via the processor, promotional pricing of the product data of the local database; and
displaying, via the processor, the promotional pricing to a consumer.

2. The computer implemented method of claim 1, wherein the data partition comprises domains for price, promotion, item, and item location service.

3. The computer implemented method of claim 1, wherein the first product characteristic comprises a stock keeping unit (SKU) identifier.

4. The computer implemented method of claim 1, wherein generating the data partition comprises generating a highly composite number of data partitions to enable horizontal scaling of the data partitions.

5. The computer implemented method of claim 1, wherein generating the data partition based on the first product characteristic comprises:
retrieving a product database;
executing a hash function on product data of the product database based on the first product characteristic; and
allocating the product data into the data partition based on the output of the hash function.

6. The computer implemented method of claim 1, wherein removing the attribute of the third data entry of the data partition comprises:
retrieving a promotion policy;
determining an attribute of the third data entry unrelated to the promotion policy; and
removing the attribute from the third data entry.

7. The computer implemented method of claim 1, wherein formatting the product data of the data partition based on the first product characteristic comprises:
determining an attribute class of the first product characteristic; and
formatting a data entry of the data partition to comprise the attribute class.

8. The computer implemented method of claim 1, wherein combining the first data entry and second data entry of the data partition into the third data entry based on the first product characteristic comprises:
determining the first product characteristic of the first data entry;
determining the first product characteristic of the second data entry;
determining that the first product characteristic of the first data entry is equivalent to the first product characteristic of the second data entry; and
combining a first data entry and the second data entry into a third data entry, wherein duplicate attributes of the first data entry and second data entry are removed.

9. The computer implemented method of claim 1, wherein joining the product data of the data partition into the local database further comprises:
executing a hash function on the product data based on a second product characteristic; and
sorting the product data into the local database based on the output of the hash function.

10. The computer implemented method of claim 9, wherein the second product characteristic represents a target characteristic of a conditional promotion and comprises one of a consumer characteristic, consumer location characteristic, product item characteristic, product class characteristic, store location characteristic, or manufacture characteristic.

11. The computer implemented method of claim 1, wherein evaluating promotional pricing of the product data of the local database comprises:
retrieving a conditional promotion policy;
designating a promotional product based on the conditional promotion policy; and
calculating a conditional pricing of the promotional product based on the conditional promotion policy and the product data.

12. The computer implemented method of claim 1, wherein displaying the promotional pricing to a consumer comprises:
transmitting the promotional pricing to a search engine system; and
displaying the promotional pricing to the consumer based on a search query input to the search engine system by the consumer.

13. A system for generating promotional product pricing, comprising:
a product database;
a local database; and
a processor configured by instructions to perform operations comprising:
generating a data partition based on a first product characteristic, wherein the data partition comprises product data of the product database;
formatting product data of the data partition based on the first product characteristic;
joining product data of the data partition into the local database, comprising:
combining a first data entry and second data entry of the data partition into a third data entry based on the first product characteristic; and
removing an attribute of the third data entry of the data partition;
evaluating promotional pricing of the product data of the local database; and
displaying the promotional pricing to a consumer.

14. The system of claim 13, wherein generating the data partition based on the first product characteristic comprises:
retrieving a product database;
executing a hash function on product data of the product database based on the first product characteristic; and
allocating the product data into the data partition based on the output of the hash function.

15. The system of claim 13, wherein removing the attribute of the third data entry of the data partition comprises:
retrieving a promotion policy;
determining an attribute of the third data entry unrelated to the promotion policy; and
removing the attribute from the third data entry.

16. The system of claim 13, wherein formatting the product data of the data partition based on the first product characteristic comprises:
determining an attribute class of the first product characteristic; and
formatting a data entry of the data partition to comprise the attribute class.

17. The system of claim 13, wherein combining the first data entry and second data entry of the data partition into the third data entry based on the first product characteristic comprises:
determining the first product characteristic of the first data entry;
determining the first product characteristic of the second data entry;
determining that the first product characteristic of the first data entry is equivalent to the first product characteristic of the second data entry; and
combining a first data entry and the second data entry into a third data entry, wherein duplicate attributes of the first data entry and second data entry are removed.

18. The system of claim 13, wherein joining the product data of the data partition into the local database further comprises:
executing a hash function on the product data based on a second product characteristic; and
sorting the product data into the local database based on the output of the hash function.

19. The system of claim 13, wherein evaluating promotional pricing of the product data of the local database comprises:
retrieving a conditional promotion policy;
designating a promotional product based on the conditional promotion policy; and
calculating a conditional pricing of the promotional product based on the conditional promotion policy and the product data.

20. The system of claim 13, wherein displaying the promotional pricing to a consumer comprises:
transmitting the promotional pricing to a search engine system; and
displaying the promotional pricing to the consumer based on a search query input to the search engine system by the consumer.
